(19) United States
(12) Patent Application Publication
(10) Pub. No.: US 2024/0080055 A1
(43) Pub. Date: Mar. 7, 2024

(54) ANTENNA IMPEDANCE AND FREQUENCY TUNING USING PHYSICAL-INTERACTION DETECTION AIDED BY MACHINE LEARNING

(71) Applicant: Samsung Electronics Co., Ltd., Suwon-si (KR)

(72) Inventors: Panagiotis Skrimponis, San Diego, CA (US); Pranav Dayal, San Diego, CA (US); Wan Jong Kim, Tustin, CA (US)

(21) Appl. No.: 18/180,712

(22) Filed: Mar. 8, 2023

Related U.S. Application Data
(60) Provisional application No. 63/403,605, filed on Sep. 2, 2022.

(51) Int. Cl. H04B 1/10; H04B 1/7136; H04W 72/0453

(52) U.S. Cl. CPC H04B 1/1027; H04B 1/7136; H04W 72/0453; H04B 2001/1072; H04B 2001/71365

(57) ABSTRACT

A method, user equipment, and system are disclosed for adjusting a user equipment (UE) configuration based on physical factors at the UE. The method comprises receiving, by a neural network circuit, inputs related to a physical interaction with the UE, the inputs including at least one of a first input value associated with a reflection coefficient of the UE, a second input value associated with a frequency band for transmitting or receiving a signal with the UE, and a third input value associated with a carrier frequency for transmitting or receiving the signal with the UE, outputting output values associated with detecting a use case of the physical interaction or associated with adjusting at least one of an antenna impedance and an antenna aperture of the UE, and adjusting at least one of an impedance tuner circuit and an aperture tuner circuit of the UE based on the output values.

### CROSS-REFERENCE TO RELATED APPLICATION

This application claims the priority benefit under 35 U.S.C. § 119(e) of U.S. Provisional Application No. 63/403,605, filed on Sep. 2, 2022, the disclosure of which is incorporated by reference in its entirety as if fully set forth herein.

### TECHNICAL FIELD

The disclosure generally relates to wireless communications. More particularly, the subject matter disclosed herein relates to improvements to detecting and responding to a physical interaction with a user equipment.

### SUMMARY

A modern communication device (e.g., a user equipment (UE)) may be configured to make determinations about physical interactions with the UE. For example, a UE may determine that a human body is near the UE and may reduce the UE's transmit power to satisfy a specific absorption rate (SAR) requirement for safe operation. Additionally, a user of a UE may change an antenna load of the UE when handling the UE through, what may be referred to as, the human-body effect (or human body shadowing). For example, a UE's performance may become degraded due to the changed antenna load caused by a physical interaction with the UE. Thus, a UE may be configured to detect (e.g., determine a classification for) different physical interactions with the UE and respond to the detected interactions as appropriate in a given situation. For example, a UE may determine that an antenna load has changed and may respond by tuning the antenna impedance or tuning the antenna frequency. Frequency tuning is referred to herein as aperture tuning. The UE may tune the antenna impedance or aperture to provide for an increased transmission power. The UE may determine that the physical interaction with the UE corresponds to a use case wherein increasing the transmission power would not place a human at a health risk.

To solve the problem of detecting a physical interaction with a UE, grip sensors may be placed across an area of the UE to detect the human-body effect. For example, a grip sensor may sense the temperature of the UE. One issue with this approach is that the usefulness and accuracy of grip sensors may be limited because grip sensors may not be placed over the entirety of the UE.

To solve the problem of responding to a performance degradation due to the human-body effect by impedance or aperture tuning, some approaches rely on a lookup Table (LUT) method. One issue with this approach is that it consumes a lot of memory to save data associated with the LUT. For example, an LUT may store impedance information or frequency information along with corresponding impedance tuner codes or corresponding aperture tuner codes.

Some approaches rely on a parasitic model of the UE. For example, the UE system may be mathematically modeled to produce a parasitic model of the UE and impedance changes may be detected and adjusted based on the parasitic model.

One issue with this approach is that the usefulness and accuracy of a parasitic-modeling approach may be limited because a detector for detecting a change in impedance based on the parasitic model may not be able to distinguish between specific use cases (e.g., a right-hand grip, a left-hand grip, placed on a desk, etc.). Another issue with this approach is that it may involve developing complex mathematical models, which are topology specific. Thus, a parasitic-modeling approach may be less flexible for modeling different UEs and may involve additional research and development costs.

To overcome these issues, systems and methods are described herein for using machine learning and a feedback signal from a transmit antenna to: (i) detect a user interaction with a UE and (ii) provide impedance tuning or aperture tuning to improve the performance of the UE based on the user interaction with the UE.

Some embodiments of the present disclosure provide for a neural network classifier with input values that allow for improved identification of user interactions with the UE.

Some embodiments of the present disclosure provide for a neural network model that may be used as an alternative to a parasitic model for determining a target tuner code.

Some embodiments of the present disclosure provide for a neural network model that may be used as a black box to model a tuner model within the parasitic model to determine a target tuner code.

Some embodiments of the present disclosure provide for a neural network model and corresponding cascade system for a generalized physical-interaction detection model for different tuner codes.

The above approaches improve on previous methods because they may enable a UE to make a more accurate classification of user interactions with the UE and may allow for more flexibility in finding improved tuner adjustments for different UE topologies.

According to some embodiments of the present disclosure, a method of adjusting a UE configuration based on physical factors at the UE includes receiving, by a neural network circuit of the UE, one or more inputs related to a physical interaction with the UE, the one or more inputs including at least one of a first input value associated with a reflection coefficient of the UE, a second input value associated with a frequency band for transmitting or receiving a signal with the UE, and a third input value associated with a carrier frequency for transmitting or receiving the signal with the UE, outputting, by the neural network circuit, one or more output values associated with detecting a use case of the physical interaction or associated with adjusting at least one of an antenna impedance and an antenna aperture of the UE, and adjusting at least one of an impedance tuner circuit and an aperture tuner circuit of the UE based on the one or more output values.

The second input value may include a correlation coefficient correlating two frequency bands for transmitting or receiving the signal with the UE.

The neural network circuit may include a regression neural network configured to output a reflection coefficient corresponding to a target tuner code, based on one or more input values including a bypass reflection coefficient and a tuner code.

The regression neural network may be configured to serve as a model for a transfer function associated with an antenna model, a tuner model, and a radio frequency printed circuit board (RF PCB) model of the UE.

The regression neural network may be configured to serve as a model for only the tuner model of the UE.

The outputting of the one or more output values may include outputting a tuner code based on a voltage standing wave ratio (VSWR).

The outputting of the one or more output values may include outputting a tuner code based on a relative transducer gain (RTG).

The outputting of the one or more output values may include determining a use case based on a cascade system including a regression neural network having an output coupled to an input of a classification neural network.

According to other embodiments of the present disclosure, a UE for adjusting a configuration of the UE based on physical factors at the UE includes an antenna having an antenna impedance and an antenna aperture, a tuner circuit configured to adjust at least one of the antenna impedance and the antenna aperture, and a neural network circuit configured to receive one or more inputs related to a physical interaction with the UE, the one or more inputs including at least one of a first input value associated with the antenna impedance, a second input value associated with a frequency band for transmitting or receiving a signal with the antenna, and a third input value associated with a carrier frequency for transmitting or receiving the signal with the antenna, output one or more output values associated with detecting a use case of the physical interaction or associated with adjusting at least one of the antenna impedance and the antenna aperture, and transmit the one or more output values to the tuner circuit.

The second input value may include a correlation coefficient correlating two frequency bands for transmitting or receiving the signal with the UE.

The neural network circuit may include a regression neural network configured to output a reflection coefficient corresponding to a target tuner code, based on one or more input values including a bypass reflection coefficient and a tuner code.

The regression neural network may be configured to serve as a model for a transfer function associated with an antenna model, a tuner model, and a radio frequency printed circuit board (RF PCB) model of the UE.

The regression neural network may be configured to serve as a model for only the tuner model of the UE.

The outputting of the one or more output values may include outputting a tuner code based on a voltage standing wave ratio (VSWR) or based on a relative transducer gain (RTG).

The neural network circuit may be configured to output the one or more output values based on determining a use case based on a cascade system including a regression neural network having an output coupled to an input of a classification neural network.

According to other embodiments of the present disclosure, a system for adjusting a user equipment (UE) configuration based on physical factors at the UE includes the UE configured to be communicably coupled with a network node, the UE including an antenna, a tuner circuit configured to adjust at least one of an antenna impedance and an antenna aperture, and a neural network circuit, the neural network circuit being configured to receive one or more inputs related to a physical interaction with the UE, the one or more inputs including at least one of a first input value associated with an antenna impedance of the antenna, a second input value associated with a frequency band for transmitting or receiving a signal with the antenna, and a third input value associated with a carrier frequency for transmitting or receiving the signal with the antenna, output one or more output values associated with detecting a use case of the physical interaction or associated with adjusting at least one of the antenna impedance and adjusting the antenna aperture, and transmit the one or more output values to the tuner circuit to adjust at least one of the antenna impedance and the antenna aperture, wherein the UE is configured to transmit a signal to the network node, by way of the antenna, based on at least one of an adjusted antenna impedance and an adjusted antenna aperture.

The second input value may include a correlation coefficient correlating two frequency bands for transmitting or receiving the signal with the UE.

The neural network circuit may include a regression neural network configured to output a reflection coefficient corresponding to a target tuner code, based on one or more input values including a bypass reflection coefficient and a tuner code.

The regression neural network may be configured to serve as a model for a transfer function associated with an antenna model, a tuner model, and a radio frequency printed circuit board (RF PCB) model of the UE.

The neural network circuit may be configured to output the one or more output values based on determining a use case based on a cascade system including a regression neural network having an output coupled to an input of a classification neural network.

### BRIEF DESCRIPTION OF THE DRAWINGS

In the following section, the aspects of the subject matter disclosed herein will be described with reference to exemplary embodiments illustrated in the figures, in which:

FIG. 1A is a block diagram depicting a system including a user equipment (UE) and a network node, in communication with each other, according to some embodiments of the present disclosure.

FIG. 1B is a block diagram depicting components of the UE, according to some embodiments of the present disclosure.

FIG. 2 is a block diagram depicting a system for collecting use-case data to train a neural network for classifying a physical interaction with the UE, according to some embodiments of the present disclosure.

FIG. 3 is a diagram depicting a neural network for classifying a physical interaction with the UE, according to some embodiments of the present disclosure.

FIG. 4A is a diagram depicting a graphical user interface (GUI) for testing a neural network, according to some embodiments of the present disclosure.

FIG. 4B is a diagram depicting an example classification area corresponding to a frequency band, according to some embodiments of the present disclosure.

FIG. 5A is a diagram depicting a structure of a transfer function model for determining a reflection coefficient, according to some embodiments of the present disclosure.

FIG. 5B is a diagram depicting a neural network serving as a stand-alone regression model for determining a target tuner code, according to some embodiments of the present disclosure.

FIG. 5C is a diagram depicting a neural network serving as a regression model for estimating a tuner model and reference ABC parameters within a transfer function model for determining a target tuner code, according to some embodiments of the present disclosure.

FIG. 6 is a diagram depicting a neural network model for estimating a tuner code, according to some embodiments of the present disclosure.

FIG. 7 is a diagram depicting a cascade system for a generalized physical-interaction detection model for different tuner codes, according to some embodiments of the present disclosure.

FIG. 8 is a block diagram of an electronic device in a network environment, according to some embodiments of the present disclosure.

FIG. 9 is a flowchart depicting example operations of a method of adjusting a UE configuration based on physical factors at the UE, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

A “correlation coefficient” as used herein refers to a number between −1 and +1 used to represent the strength of a linear relationship between two different variables, such as frequencies or frequency bands.

A “neural network circuit” as used herein refers to a circuit including one or more neural networks provided to leverage machine learning to infer an output, based on one or more input values. Some examples of a “neural network circuit” include circuits, which include regression neural networks, classification neural networks, and/or the like.

A “regression neural network” as used herein refers to a neural network that has been trained to predict an output value based on the neural network inputs.

A “relative transducer gain (RTG)” as used herein refers to the power available to a load relative to an input power available from a source.

A “transfer function” as used herein refers to a mathematical function that models a system's output for each possible input.

A “tuner code” as used herein refers to an input value for a tuner circuit, which instructs the tuner circuit on how to adjust an impedance or frequency associated with an antenna.

A “user equipment” as used herein refers to an electronic device configured for wireless communications. Some examples of a “user equipment” are a mobile phone, smart phone, laptop computer, tablet, etc.

A “voltage standing wave ratio (VSWR)” as used herein refers to a ratio between transmitted and reflected voltage standing waves in a radio frequency (RF) transmission circuit.

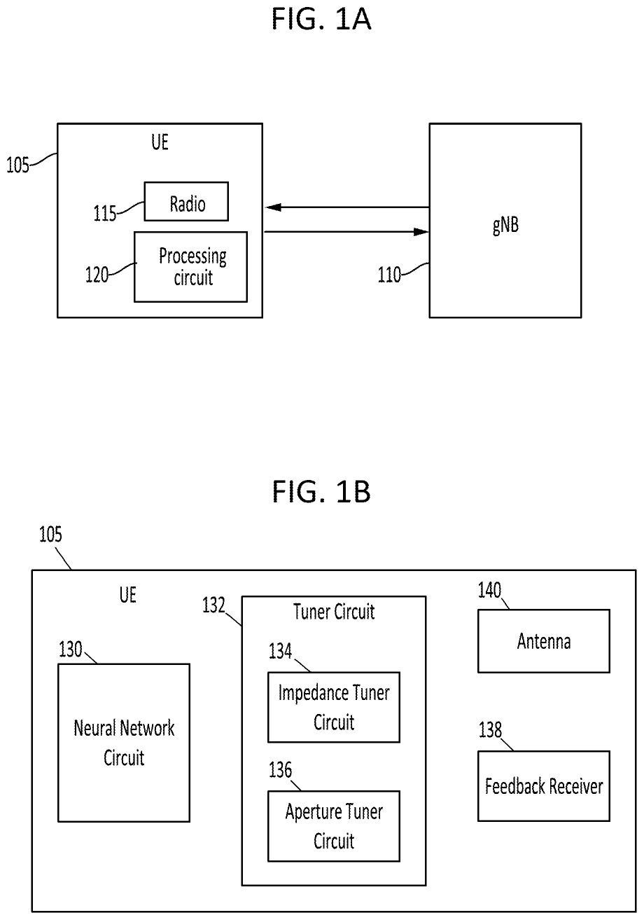

FIG. 1A is a block diagram depicting a system including a user equipment (UE) 105 and a network node 110, in communication with each other.

Referring to FIG. 1A, the UE 105 may include a radio 115 and a processing circuit 120 (or a means for processing), which may perform various methods disclosed herein. For example, the processing circuit 120 may receive, via the radio 115, transmissions from the network node 110, and the processing circuit 120 may transmit, via the radio 115, signals to the network node 110.

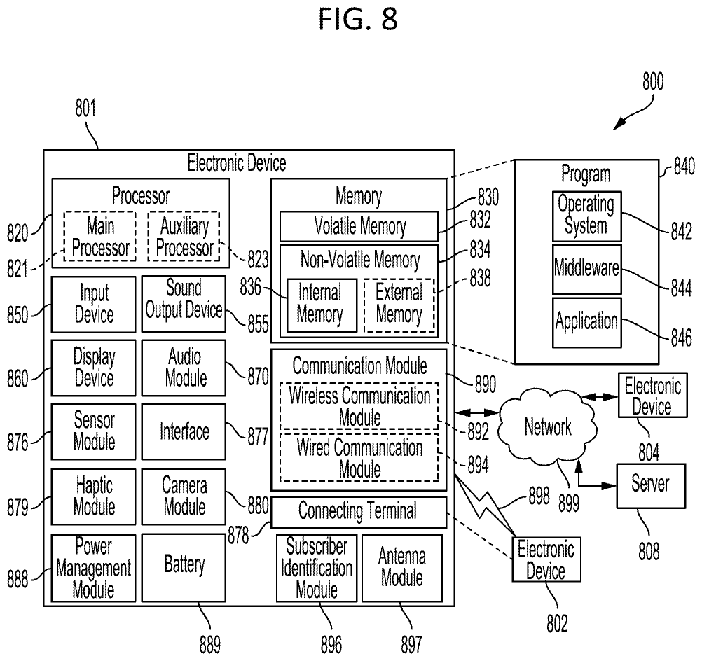

The UE 105 may include the electronic device 801 of FIG. 8. In some embodiments of the present disclosure, the network node 110 may be included in a first network 898 of FIG. 8. In some embodiments of the present disclosure, the network node 110 may be included in a second network 899 of FIG. 8. The radio 115 may include the wireless communication module 892 of FIG. 8. The radio 115 may include the antenna module 897 of FIG. 8. The processing circuit 120 may include the processor 820 of FIG. 8.

FIG. 1B is a block diagram depicting components of a UE 105, according to some embodiments of the present disclosure.

Referring to FIG. 1B, the UE 105 may include a neural network circuit 130 and a tuner circuit 132. The tuner circuit 132 may include an impedance tuner circuit 134 for making antenna impedance adjustments. The tuner circuit 132 may include an aperture tuner circuit 136 for making frequency adjustments by way of adjusting an antenna aperture. It should be understood that the methods described herein for antenna impedance adjustments may similarly be applied to aperture adjustments, and vice versa. In some embodiments of the present disclosure, the neural network circuit 130 may include one or more neural networks for generating output values associated with detecting a physical interaction use case. In some embodiments of the present disclosure, the neural network circuit 130 may include one or more neural networks for generating output values associated with adjusting at least one of an antenna impedance and an antenna aperture of the UE 105. The UE 105 may include an antenna 140 for transmitting and receiving signals with the UE 105. The UE 105 may include a feedback receiver 138. The feedback receiver 138 may be used to determine a reflection coefficient associated with a signal transmitted or received by the UE 105. It should be understood that the reflection coefficient is associated with the antenna impedance. For example, the reflection coefficient describes a degree to which a radio waveform is reflected based on the antenna impedance.

In some embodiments of the present disclosure, the neural network circuit 130 may include a combination of software components and hardware components corresponding to the processor 820 and the memory 830 of FIG. 8. In some embodiments of the present disclosure, the tuner circuit 132 may be included in the communication module 890 of FIG. 8. In some embodiments of the present disclosure, the tuner circuit 132 may be included in the antenna module 897 of FIG. 8. In some embodiments of the present disclosure, the impedance tuner circuit 134 may be included in the communication module 890 of FIG. 8. In some embodiments of the present disclosure, the impedance tuner circuit 134 may be included in the antenna module 897 of FIG. 8. In some embodiments of the present disclosure, the aperture tuner circuit 136 may be included in the communication module 890 of FIG. 8. In some embodiments of the present disclosure, the aperture tuner circuit 136 may be included in the antenna module 897 of FIG. 8. The antenna 140 may be included in the antenna module 897 of FIG. 8. In some embodiments of the present disclosure, the feedback receiver 138 may be included in the communication module 890 of FIG. 8. In some embodiments of the present disclosure, the feedback receiver 138 may be included in the antenna module 897 of FIG. 8.

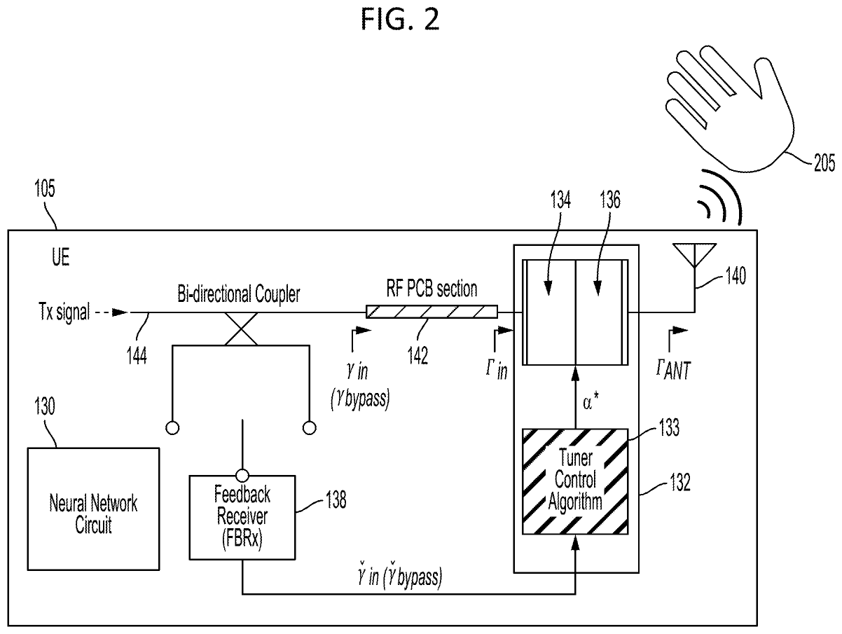

FIG. 2 is a block diagram depicting a system for collecting use-case data to train a neural network for classifying a physical interaction with the UE 105, according to some embodiments of the present disclosure.

Referring to FIG. 2, a physical interaction 205 with the UE 105 may deflect power associated with an antenna 140 from the antenna 140 back toward a feedback receiver 138. For example, the physical interaction 205 with the UE 105 may deflect power back along a path corresponding to an impedance tuner circuit 134 and an aperture tuner circuit 136, a radio frequency printed circuit board (RF PCB) section 142, and a bi-directional coupler 144 to be detected by the feedback receiver 138. Accordingly, the feedback receiver 138 may be used in the UE 105 to detect impedance and frequency changes corresponding to the physical interaction 205 with the UE 105. The feedback receiver 138 may output values corresponding to the physical interaction 205 to a tuner circuit 132. The tuner circuit 132 may include a tuner control algorithm 133, the impedance tuner circuit 134, and the aperture tuner circuit 136. The tuner control algorithm may select a better impedance tuner code or a better aperture tuner code based on the output values from the feedback receiver 138. Although the present disclosure refers to human interactions with the UE (e.g., a type of hand grip on the UE), it should be understood that the present disclosure is not limited thereto. For example, a physical interaction with the UE may include any interaction related to the presence or proximity of another physical object with respect to the UE.

A data collection process for training the neural network according to the present disclosure may involve the following operations. The bi-directional coupler 144 may read a reflection coefficient \hat{γ}ᵢₙ^{(α)} at the input of the feedback receiver 138. A signal (e.g., a data sequence) may be transmitted over the antenna 140. The feedback receiver 138 may be used to read the signal, perform a correlation (e.g., a correlation between two frequency bands of the transmission for each corresponding use case), and estimate the forward signal path and the reverse signal path of the transmission. A reflection coefficient \hat{γ}ᵢₙ^{(α)} for any given tuner code (α) may be determined using the ratio of the forward over the reverse path.

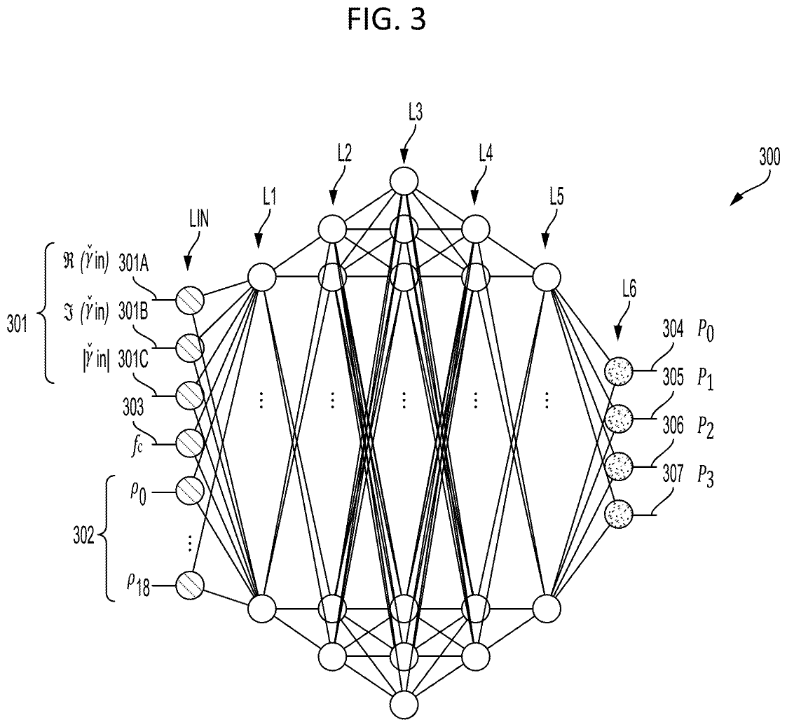

FIG. 3 is a diagram depicting a neural network for classifying a physical interaction with the UE 105, according to some embodiments of the present disclosure.

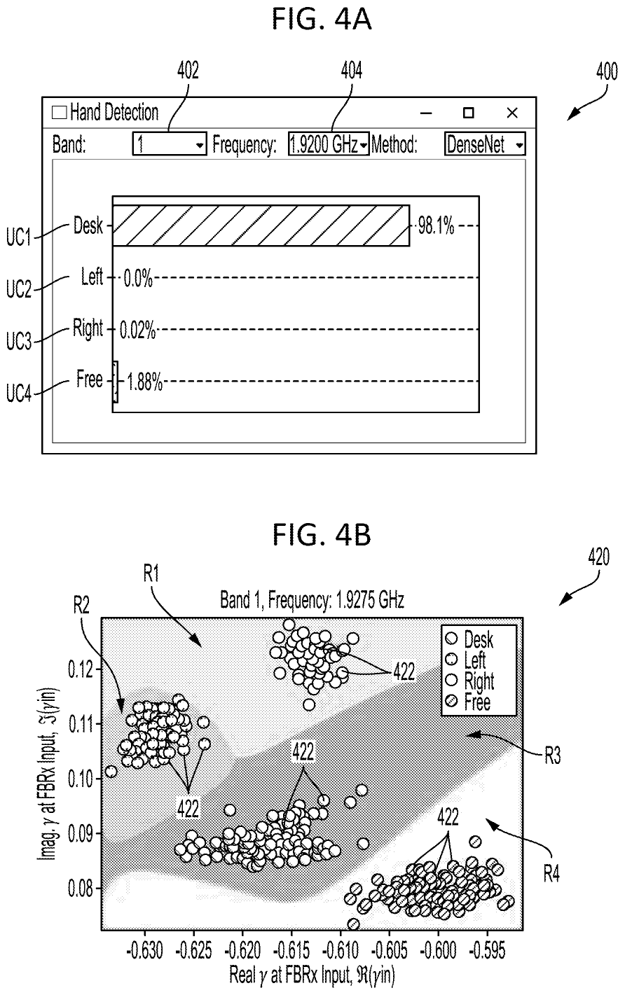

Referring to FIG. 3, a neural network classifier 300 may be included in the neural network circuit 130 (see FIGS. 1B and 2). The neural network classifier 300 may be trained to classify different physical interactions (e.g., physical-medium interactions or physical-force interactions) into different use cases by analyzing data points (e.g., impedance and frequency measurements) for all frequency bands and carrier frequencies that may be used by a UE 105 (see FIGS. 1A-2) in practice. As will be discussed below, in reference to FIGS. 4A and 4B, data (e.g., including real and synthetic data) may be linearly separated into respective use cases for each frequency band and carrier frequency. The neural network classifier 300 may be a neural network used as a classifier to determine the probability that a given set of inputs to the neural network classifier 300 correspond to specific use cases. As a simple example, the use cases may correspond to measurements taken with a feedback receiver 138 (see FIG. 2) while the UE 105 is placed on a desk, gripped by a human's left hand, gripped by a human's right hand, and located in free space (e.g., the UE's antenna may be unobstructed by any objects).

In some embodiments of the present disclosure, the neural network classifier 300 may be a fully-connected neural network (e.g., a 6-layer fully-connected neural network). For example, the neural network classifier 300 may include an input layer LIN and an output layer, corresponding to the sixth layer L6, and five hidden layers L1-L5.

The neural network classifier 300 may have the following as input features: (i) the reflection coefficient at the input of the feedback receiver 138 (see FIG. 2) when the impedance tuner circuit 134 and the aperture tuner circuit 136 are bypassed (e.g., operating in bypass mode) (\hat{γ}_{bypass}); (ii) the frequency band (b); and (iii) the carrier frequency (f_{c}).

The first input features to the neural network classifier 300 may be associated with the reflection coefficient. The reflection coefficient is a complex number, including real and imaginary parts. However, neural network methods are designed for real inputs. To cope with this issue, in some embodiments, the real part and the imaginary part of the number may be passed as two separate input channels to the neural network classifier 300. For example, as shown in FIG. 3, first input values 301 may correspond to the reflection coefficient, which is a measure of impedance, measured by the feedback receiver 138 during a physical interaction 205 with the UE 105. The first input values 301 may include a real value of the reflection coefficient at input 301A, an imaginary value of the reflection coefficient at input 301B, and a magnitude value of the reflection coefficient at input 301C. The magnitude value of the reflection coefficient may be provided to enable the neural network classifier 300 to understand a relationship between the real value at input 301A and the imaginary value at input 301B. The real and imaginary channels (corresponding to inputs 301A and 301B) may have values in the range of [−1, 1] and the magnitude channel may have values in the range of [0, 1].

As an alternative to inputting the real and imaginary parts of the reflection coefficient to the neural network classifier 300, the magnitude and the angle of the complex number may be passed as two separate input channels to the neural network classifier 300. Accordingly, the neural network classifier 300 may receive one or more input values corresponding to the reflection coefficient and, thus, associated with an antenna impedance, to classify different physical interactions with the UE.

The second input features to the neural network classifier 300 may be associated with the frequency band (b) (e.g., an LTE band) used to transmit or receive the signal with the UE, which resulted in the measured reflection coefficient discussed above. For example, second input values 302 may be associated with identifying the frequency band corresponding to the first input values 301. For example, an LTE transmission may occur on any one of 19 bands. Thus, the second input values 302, when used for LTE transmissions, may correspond to a band index having 19 input values.

Because the frequency band input feature may take discrete values with an arbitrary meaning, an embedding layer may be used to accurately represent this information. Simply normalizing the second input values 302 might not be able to convey the correct information. To cope with this issue, two alternative options may be used. In some embodiments of the present disclosure, a lookup table layer of fixed dictionary and size may be used to generate a code based on a given index. Based on the analysis, an average correlation coefficient between the frequency bands may be used to represent the information. For example, a correlation coefficient may be provided to correlate two or more frequency bands for transmitting or receiving a signal with the user equipment to improve accuracy. That is, because reflection coefficients (or antenna impedances) are somewhat correlated at different frequencies, the relationship between different frequencies for different use cases, as indicated by their correlation coefficients, may be used to improve the accuracy of the neural network classifier 300. Alternatively, in some embodiments of the present disclosure, a trainable embedding layer may be used. The first option (the lookup table layer option) relies on prior data analysis, while the latter option (the trainable embedding layer option) does not rely on prior data analysis, may be more flexible, and may enable the neural network classifier 300 to learn more complex relationships from the input features.

The third input features to the neural network classifier 300 may be associated with the carrier frequency (f_{c}) feature. For example, third input values 303 may be associated with the carrier frequency, which may take values within a specific range for a given input frequency band. For example, for LTE band 7, the uplink carrier frequency may take a value between 2.5 and 2.57 GHz. In some embodiments of the present disclosure, the carrier frequency information may be passed to the neural network classifier 300 by normalizing all available carrier frequencies within a specific range (e.g., [0, 1] or [−1, 1]). In some embodiments of the present disclosure, the carrier frequency information may be passed to the neural network classifier 300 by normalizing the frequencies inside each band within a specific range (e.g., [0, 1] or [−1, 1]).

In summary, in some embodiments of the present disclosure, the input channels of the neural network classifier 300 may include: (i) a real part of the bypass reflection coefficient (the reflection coefficient measured at the input of the feedback receiver when the impedance tuner circuit 134 and the aperture tuner circuit 136 are bypassed); (ii) an imaginary part of the bypass reflection coefficient; (iii) a magnitude of the bypass reflection coefficient; (iv) a frequency index corresponding to a carrier frequency (e.g., [0, 8]); and (v) either a corresponding frequency band index (e.g., an LTE band index in [0, 18]) or a corresponding LTE band correlation coefficient.

The outputs 304-307 of the neural network classifier 300 may include probabilities that the corresponding first input values 301, second input values 302, and third input values 303 belong to one of the use cases (Pr(C=Cᵢ|\hat{γ}_{bypass},b,f_{c}).

To train the neural network classifier 300, an Adam optimizer may be used. Additionally, a custom scheduling algorithm may be used to reduce the learning rate among iterations. A negative log likelihood (NLL) may be used as a cost metric. In some embodiments of the present disclosure, 50 epochs and a batch size of 256 may be used. A starting learning rate of 1e−3 may be used.

FIG. 4A is a diagram depicting a graphical user interface (GUI) for testing a neural network, according to some embodiments of the present disclosure.

FIG. 4B is a diagram depicting an example classification area corresponding to a frequency band, according to some embodiments of the present disclosure.

Referring to FIG. 4A, GUI 400 may be used in the training of machine learning models for inference. For example, the GUI 400 may be used to control a reference UE, using attention (AT) commands. The UE may use trained machine learning models for inference. The GUI 400 may include a frequency band field 402 and a carrier frequency field 404. The GUI 400 may depict the outputs 304-307 of the trained neural network classifier 300 (see FIG. 3) along with their respective use cases UC1-UC4. For example, a first use case UC1 may correspond to a physical interaction 205 with the UE 105 (see FIG. 2) wherein the UE 105 is placed on a desk; a second use case UC2 may correspond to a physical interaction 205 with the UE 105 wherein the UE 105 is grasped by a human's left hand; a third use case UC3 may correspond to a physical interaction 205 with the UE 105 wherein the UE 105 is grasped with a human's right hand; and a fourth use case UC4 may correspond to a physical interaction 205 with the UE 105 wherein the UE 105 is unobstructed by any objects (e.g., the UE is in free space). Based on input values received by a neural network classifier 300 of the UE 105, the neural network classifier 300 may output the probabilities that the inputs correspond to each respective use case UC1-UC4.

Referring to FIG. 4B, data points 422 corresponding to different frequency bands and carrier frequencies may be classified into different use cases. Some of the data points 422 may correspond to actual (or real) measured data. For example, reflection coefficients may be measured on a UE with respect to each frequency band and carrier frequency for each of the use cases. These data points 422 may then define different regions corresponding to different use cases. For example, a data point 422 corresponding to a first region R1 of a reflection-coefficient plot 420 may correspond to the first use case UC1; a second data point 422 corresponding to a second region R2 of the reflection-coefficient plot 420 may correspond to the second use case UC2; a third data point 422 corresponding to a third region R3 of the reflection-coefficient plot 420 may correspond to the third use case UC3; and a fourth data point 422 corresponding to a fourth region R4 of the reflection-coefficient plot 420 may correspond to the fourth use case UC4.

Because a data driven approach to detecting and responding to physical interactions with a UE may be improved by using larger numbers of data points, and because collecting real data measurements may be time consuming, some embodiments of the present disclosure may use synthetic data, generated based on an analysis of the real data, to train machine learning models. For example, a Gaussian distribution (e.g., the following multivariate Gaussian distribution) may be used to model the real data points 422 and generate synthetic data points 422:

$$N ( μ , Σ ) = \frac{1}{\sqrt{{( 2 π )}^{k} \vert Σ \vert}} {e}^{- \frac{1}{2} {( x - μ )}^{T} {\sum }^{- 1} ( x - μ )} . \qquad ( Eq . 1 )$$

In the equation above, N(μ,Σ) is the normal distribution; μ is the mean; Σ is the covariance matrix, and x is the real k-dimensional column vector.

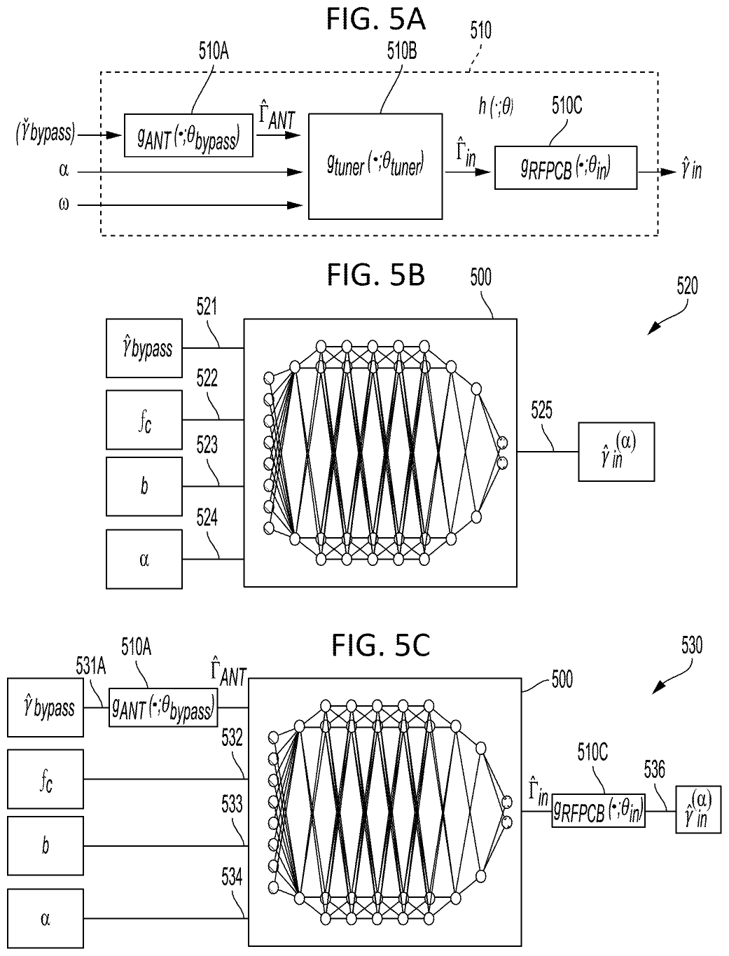

FIG. 5A is a diagram depicting a structure of a transfer function model for determining a reflection coefficient (\hat{γ}ᵢₙ), according to some embodiments of the present disclosure.

Referring to FIG. 5A, as discussed above, to determine an output value associated with adjusting an antenna impedance or an antenna aperture to improve the performance of a UE 105, due to a changed antenna impedance associated with a physical interaction 205 with the UE 105 (see FIG. 2), some approaches rely on a parasitic model 510 of the UE 105. For example, a VSWR may be used as a metric to find a tuner code (α) for improving the performance of a UE. According to this approach, a transfer function h(⋅; θ) corresponding to the parasitic model 510 may be used, along with the bypass reflection coefficient (\hat{γ}_{bypass}), the carrier frequency (f_{c}), and impedance tuner code (α), to estimate the reflection coefficient (\hat{γ}ᵢₙ^{(α)}) at the input of the feedback receiver 138 (see FIG. 2), for an arbitrary tuner code (α). Accordingly, the RTG may be used to determine an improved tuner code based on a measured bypass reflection coefficient. The improved tuner code may correspond to an adjustment to the impedance tuner circuit to improve the performance of the UE 105 based on a physical interaction 205 (see FIG. 2). According to this approach, a parasitic model may be used to provide a tuner model 510B and two-port network structures may be assumed for an antenna model 510A and an RF PCB model 510C. Furthermore, ABC parameters of the two-port networks may be estimated to find the S-Parameters.

As discussed above, the parasitic model approach is topology dependent and may not be sufficiently flexible for some applications.

FIG. 5B is a diagram depicting a neural network serving as a stand-alone regression model for determining a target tuner code (\hat{γ}ᵢₙ^{(α)} ), according to some embodiments of the present disclosure.

Referring to FIG. 5B, some embodiments of the present disclosure may use a topology-agnostic model 520, including a regression neural network 500 to estimate the reflection coefficient (\hat{γ}ᵢₙ^{(α)}) at the input of the feedback receiver 138 (see FIG. 2), for an arbitrary tuner code (α). The topology-agnostic model 520 may be included in the neural network circuit 130 (see FIGS. 1B and 2). The regression neural network 500 may be a fully-connected neural network designed as a regression model for the transfer function h(⋅;θ) of the UE 105. In some embodiments of the present disclosure, the regression neural network 500 may be a 9-layer fully-connected neural network.

The inputs 521-524 of the topology-agnostic model 520 may include the bypass reflection coefficient at input 521, the carrier frequency at input 522, the frequency band at input 523, and the tuner code (α) at input 524. The output 525 of the regression neural network 500 may be the reflection coefficient (\hat{γ}ᵢₙ^{(α)}) at the output of the feedback receiver 138 (see FIG. 2), corresponding to the tuner code (α) at input 524.

To train the regression neural network 500 for the topology-agnostic model 520, an Adam optimizer may be used. Additionally, a mean squared error (MSE) may be used as the cost function. An adaptive learning rate may be used, and the learning rate may be reduced every few epochs. Training may start from 1e−2 and go all the way down to 5e−5. This training approach may achieve about −34.5 dB MSE and about −24.7 dB normalized mean square error (NMSE). Accordingly, this machine learning model, using a regression neural network 500, may be used to accurately predict the reflection coefficient (\hat{γ}ᵢₙ).

Also referring to FIG. 5B, for the aperture tuning, a regression neural network 500 may be used. The regression neural network 500 for aperture tuning may have the following input features: (i) the bypass reflection coefficient (\hat{γ}_{bypass}) at input 521; (ii) the carrier frequency (f_{c}) at input 522, the frequency band (b) at input 523, and the target tuner code at input 524. The output 525 of the regression neural network 500 may be the reflection coefficient at the input of feedback receiver 138 when the impedance tuner circuit 134 is in bypass mode and the aperture tuner circuit is set with the target tuner code.

To train the regression neural network 500 for aperture tuning, an Adam optimizer may be used. Additionally, MSE may be used as the cost function. An adaptive learning rate may be used, and the learning rate may be reduced every few epochs. Training may start from 1e−2 and go all the way down to 5e−5. This training approach may achieve about −38.41 dB MSE and about −27.29 dB NMSE. Accordingly, this machine learning model, using a regression neural network 500 for aperture tuning, may be used to accurately predict the reflection coefficient (\hat{γ}ᵢₙ).

FIG. 5C is a diagram depicting a neural network serving as a regression model for estimating a tuner model and reference ABC parameters within a transfer function model for determining a target tuner code (\hat{γ}ᵢₙ^{(α)}, according to some embodiments of the present disclosure.

Referring to FIG. 5C, some embodiments of the present disclosure may use a black-box regression model 530. The black-box regression model 530 may be included in the neural network circuit 130 (see FIGS. 1B and 2). For example, a regression neural network 500 (e.g., a fully-connected neural network) may be used to estimate the tuner model 510B and the reference ABC parameters for the antenna model 510A and the RF PCB model 510C of the parasitic model 510 discussed above. According to this approach, the black-box regression model 530 may have the following input features: (i) the bypass reflection coefficient (\hat{γ}_{bypass}) at input 531A; (ii) the carrier frequency (f_{c}) at input 532; (iii) the frequency band (b) at input 533; and (iv) the target tuner code (α) at input 534. The output 536 of the black-box regression model 530 may be the reflection coefficient at the input of the feedback receiver 138 (see FIG. 2) when the aperture tuner circuit 136 is in bypass mode and the impedance tuner circuit 134 is set with the target tuner code (\hat{γ}ᵢₙ^{(α)}). In some embodiments of the present disclosure, subsequent to performing the analysis of the parasitic model 510, the input and output layers of the regression neural network 500 may be used to process the data according to the following equations:

$${\hat{Γ}}_{A N T} = \frac{{\hat{γ}}_{bypass} - {B}_{bypass}}{{A}_{bypass} - {C}_{bypass} {\hat{γ}}_{bypass}} \qquad ( Eq . 2 )$$

$${\hat{γ}}_{i n} = \frac{{A}_{i n} {\hat{Γ}}_{i n} + {B}_{i n}}{{C}_{i n} {\hat{Γ}}_{i n} + 1} \qquad ( Eq . 3 )$$

In the equations above, \hat{Γ}_{ANT} is the estimated antenna reflection coefficient; \hat{γ}_{bypass} is the bypass reflection coefficient; B_{bypass} is S′₁₁, A_{bypass} is S′₂₁S′₁₂−S′₁₁S′₂₂; C_{bypass} is −S′₂₂; \hat{γ}ᵢₙ is the measured reflection coefficient; Aᵢₙ is S₂₁S₁₂−S₁₁S₂₂; Bᵢₙ is S₁₁; Cᵢₙ is −S₂₂; \hat{Γ}ᵢₙ is the PCB section input reflection coefficient; S₁₁, S₁₂, S₂₁, and S₂₂ are S-parameters (respectively representing the input port reflection, the reverse gain, the forward gain, and the output port reflection of the antenna model 510A); and ′ denotes the S-parameters with the bypass tune code.

For the black-box regression model 530, only the tuner model 510B, from the parasitic model 510 may be considered as a black box and the ABC parameters for the antenna model 510A and the RF PCB model 510C may be estimated. Using these ABC parameters, the S-Parameters and the RTG may be used as the cost function, instead of the VSWR in a random restart hill climbing (RRHC) algorithm.

To train the regression neural network 500 for the black-box regression model 530, an Adam optimizer may be used. Additionally, a mean squared error (MSE) may be used as the cost function. An adaptive learning rate may be used, and the learning rate may be reduced every few epochs. Training may start from 1e−2 and go all the way down to 5e−5. This training approach may achieve about −33.7 dB MSE and about −23.91 dB NMSE. Accordingly, this machine learning model, using a regression neural network 500, may be used to accurately predict the reflection coefficient (\hat{γ}ᵢₙ).

Advantages of the black-box regression model 530 approach and the topology-agnostic model 520 approach over the topology-specific parasitic model 510 approach include allowing for more flexibility in modeling different UE topologies and allowing for the ability to distinguish between specific use cases.

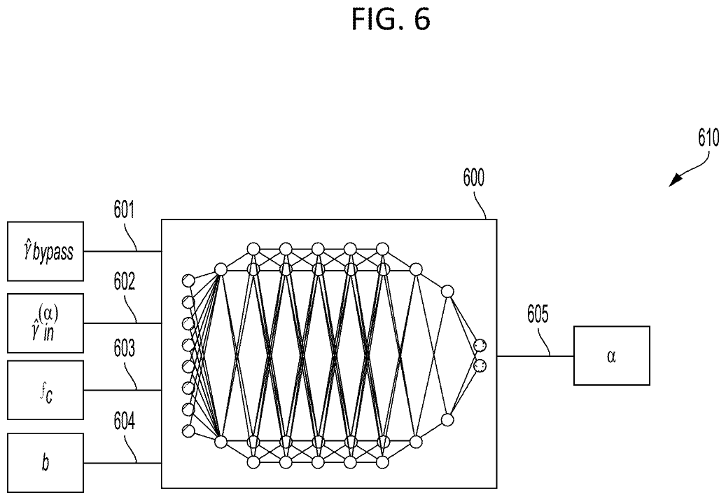

FIG. 6 is a diagram depicting a neural network model for estimating a tuner code, according to some embodiments of the present disclosure.

Referring to FIG. 6, some embodiments of the present disclosure may use a tune-code-prediction model 610. The tune-code-prediction model 610 may be included in the neural network circuit 130 (see FIGS. 1B and 2). The tune-code prediction model 610 may include a tune-code prediction neural network 600 (e.g., a fully-connected neural network). The tune-code prediction neural network 600 may include the following inputs: (i) the bypass reflection coefficient (\hat{γ}_{bypass}) at input 601; (ii) the reflection coefficient (\hat{γ}ᵢₙ^{(α)}) at the input of the feedback receiver 138 (see FIG. 2) for an arbitrary tuner code at input 602; (iii) the carrier frequency (f_{c}) at input 603; and (iv) the frequency band (b) at input 604. The output of the tune-code prediction neural network 600 is a predicted tuner code that may achieve a low (e.g., lowest) cost based on RTG and/or VSWR. The inputs and outputs of the tune-code prediction model 610 may correspond to the input and output layers of the tune-code prediction neural network 600.

To train the tune-code prediction neural network 600, an Adam optimizer may be used. Additionally, a binary cross entropy (BCE) may be used as the cost function. An adaptive learning rate may be used, and the learning rate may be reduced every few epochs. Training may start from 1e−2 and go all the way down to 5e−5. The reflection coefficient (\hat{γ}ᵢₙ) may be set to 0. The expected output of the network is the tuner code that may achieve low VSWR (e.g., |\hat{γ}ᵢₙ|≈0).

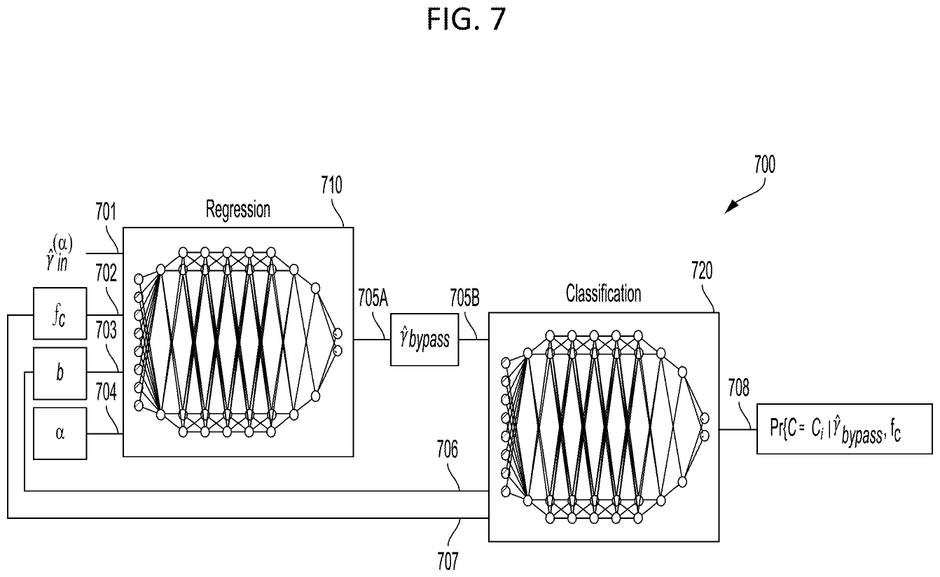

FIG. 7 is a diagram depicting a cascade system 700 for a generalized physical-interaction detection model for different tuner codes.

Referring to FIG. 7, a cascade system 700 may be used to predict a specific use case for any impedance tuner code. The cascade system 700 may be included in the neural network circuit 130 (see FIGS. 1B and 2). The cascade system 700 may include two neural networks (e.g., two fully-connected neural networks). The cascade system 700 may include an inverse-transfer-function regression neural network 710 and a generalized classification neural network 720. For example, the cascade system 700 may include a regression neural network having its output 705A coupled to an input 705B of a classification neural network. The inverse-transfer-function regression neural network 710 may be used to model the inverse of the transfer function model of \hat{γ}ᵢₙ (h⁻¹(⋅,θ)) (e.g., the inverse of the transfer function discussed above with respect to the parasitic model 510 of FIG. 5A). Accordingly, the bypass reflection coefficient (\hat{γ}_{bypass}) at the output 705A may be estimated from the following given inputs: (i) the reflection coefficient \hat{γ}ᵢₙ^{(α)} at input 701; (ii) the carrier frequency (f_{c}) at input 702; (iii) the frequency band (b) at input 703; and the impedance tuner code (α) at input 704. Then, the specific use case at output 708 of the generalized classification neural network 720 may be determined, without having to re-train the generalized classifier 720, based on the following inputs: (i) the bypass reflection coefficient at input 705B, the frequency band (b) at input 706; and the carrier frequency (f_{c}) at input 707.

FIG. 8 is a block diagram of an electronic device in a network environment 800, according to some embodiments of the present disclosure.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 840, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

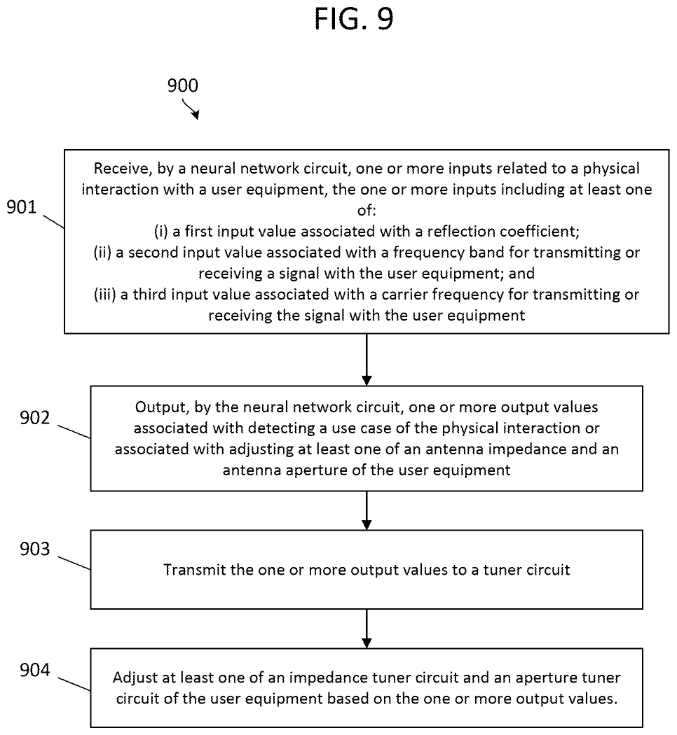

FIG. 9 is a flowchart depicting example operations of a method of adjusting a UE configuration based on physical factors at the UE, according to some embodiments of the present disclosure.

Referring to FIG. 9, a method 900 of adjusting a UE configuration based on physical factors at the UE 105 may include one or more of the following operations. A neural network circuit 130 of a UE 105 (see FIG. 1B) may receive one or more inputs related to a physical interaction with the UE 105 (operation 901). The one or more inputs may include at least one of: (i) a first input value associated with a reflection coefficient of the UE 105; (ii) a second input value associated with a frequency band for transmitting or receiving a signal with the UE 105; and (iii) a third input value associated with a carrier frequency for transmitting or receiving the signal with the UE 105 (operation 901). The neural network circuit 130 may output one or more output values associated with detecting a use case of the physical interaction or associated with adjusting at least one of the antenna impedance and an antenna aperture (or frequency) of the UE 105 (operation 902). The neural network circuit 130 may transmit one or more output values to a tuner circuit 132 of the UE 105 (operation 903). The tuner circuit 132 may adjust at least one of an impedance tuner circuit 134 and an aperture tuner circuit 136 of the UE 105 based on the one or more output values (operation 904).

The method 900 of adjusting a UE configuration based on physical factors at the UE 105 may be performed on one or more components of the electronic device 801 of FIG. 8. For example, one or more operations may be performed using a combination of software components and hardware components corresponding to the processor 820 and the memory 830 of FIG. 8.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of adjusting a user equipment (UE) configuration based on physical factors at the UE, the method comprising:
receiving, by a neural network circuit of the UE, one or more inputs related to a physical interaction with the UE, the one or more inputs comprising:
a first input value associated with a reflection coefficient of the UE;
a second input value associated with a frequency band for transmitting or receiving a signal with the UE; and
a third input value associated with a carrier frequency for transmitting or receiving the signal with the UE;
outputting, by the neural network circuit, one or more output values associated with detecting a use case of the physical interaction or associated with adjusting at least one of an antenna impedance and an antenna aperture of the UE; and
adjusting at least one of an impedance tuner circuit and an aperture tuner circuit of the UE based on the one or more output values.

2. The method of claim 1, wherein the second input value comprises a correlation coefficient correlating two frequency bands for transmitting or receiving the signal with the UE.

3. The method of claim 1, wherein the neural network circuit comprises a regression neural network configured to output a reflection coefficient corresponding to a target tuner code, based on one or more input values comprising a bypass reflection coefficient and a tuner code.

4. The method of claim 3, wherein the regression neural network is configured to serve as a model for a transfer function associated with an antenna model, a tuner model, and a radio frequency printed circuit board (RF PCB) model of the UE.

5. The method of claim 4, wherein the regression neural network is configured to serve as a model for only the tuner model of the UE.

6. The method of claim 1, wherein the outputting of the one or more output values comprises outputting a tuner code based on a voltage standing wave ratio (VSWR).

7. The method of claim 1, wherein the outputting of the one or more output values comprises outputting a tuner code based on a relative transducer gain (RTG).

8. The method of claim 1, wherein the outputting of the one or more output values comprises determining a use case based on a cascade system comprising a regression neural network having an output coupled to an input of a classification neural network.

9. A user equipment (UE) for adjusting a configuration of the UE based on physical factors at the UE, the UE comprising:
an antenna having an antenna impedance and an antenna aperture;
a tuner circuit configured to adjust at least one of the antenna impedance and the antenna aperture; and
a neural network circuit configured to:
receive one or more inputs related to a physical interaction with the UE, the one or more inputs comprising at least one of:
a first input value associated with the antenna impedance;
a second input value associated with a frequency band for transmitting or receiving a signal with the antenna; and
a third input value associated with a carrier frequency for transmitting or receiving the signal with the antenna;
output one or more output values associated with detecting a use case of the physical interaction or associated with adjusting at least one of the antenna impedance and the antenna aperture; and
transmit the one or more output values to the tuner circuit.

10. The UE of claim 9, wherein the second input value comprises a correlation coefficient correlating two frequency bands for transmitting or receiving the signal with the UE.

11. The UE of claim 9, wherein the neural network circuit comprises a regression neural network configured to output a reflection coefficient corresponding to a target tuner code, based on one or more input values comprising a bypass reflection coefficient and a tuner code.

12. The UE of claim 11, wherein the regression neural network is configured to serve as a model for a transfer function associated with an antenna model, a tuner model, and a radio frequency printed circuit board (RF PCB) model of the UE.

13. The UE of claim 12, wherein the regression neural network is configured to serve as a model for only the tuner model of the UE.

14. The UE of claim 9, wherein the outputting of the one or more output values comprises outputting a tuner code based on a voltage standing wave ratio (VSWR) or based on a relative transducer gain (RTG).

15. The UE of claim 9, wherein the neural network circuit is configured to output the one or more output values based on determining a use case based on a cascade system comprising a regression neural network having an output coupled to an input of a classification neural network.

16. A system for adjusting a user equipment (UE) configuration based on physical factors at the UE, the system comprising:
the UE configured to be communicably coupled with a network node, the UE comprising an antenna, a tuner circuit configured to adjust at least one of an antenna impedance and an antenna aperture, and a neural network circuit,
the neural network circuit being configured to:
receive one or more inputs related to a physical interaction with the UE, the one or more inputs comprising at least one of:
a first input value associated with an antenna impedance of the antenna;
a second input value associated with a frequency band for transmitting or receiving a signal with the antenna; and
a third input value associated with a carrier frequency for transmitting or receiving the signal with the antenna;
output one or more output values associated with detecting a use case of the physical interaction or associated with adjusting at least one of the antenna impedance and adjusting the antenna aperture; and
transmit the one or more output values to the tuner circuit to adjust at least one of the antenna impedance and the antenna aperture,
wherein the UE is configured to transmit a signal to the network node, by way of the antenna, based on at least one of an adjusted antenna impedance and an adjusted antenna aperture.

17. The system of claim 16, wherein the second input value comprises a correlation coefficient correlating two frequency bands for transmitting or receiving the signal with the UE.

18. The system of claim 16, wherein the neural network circuit comprises a regression neural network configured to output a reflection coefficient corresponding to a target tuner code, based on one or more input values comprising a bypass reflection coefficient and a tuner code.

19. The system of claim 18, wherein the regression neural network is configured to serve as a model for a transfer function associated with an antenna model, a tuner model, and a radio frequency printed circuit board (RF PCB) model of the UE.

20. The system of claim 16, wherein the neural network circuit is configured to output the one or more output values based on determining a use case based on a cascade system comprising a regression neural network having an output coupled to an input of a classification neural network.
